(19) United States
(12) Patent Application Publication
(10) Pub. No.: US 2021/0381822 A1
(43) Pub. Date: Dec. 9, 2021

(54) SYSTEMS AND METHODS FOR MEASURING CARGO CAPACITY

(71) Applicant: Thunderbolt Software LLC, Tuckerton, NJ (US)

(72) Inventors: Jason Burns, New Orleans, LA (US); Andrew Winkler, Cherry Hill, NJ (US)

(21) Appl. No.: 17/339,030

(22) Filed: Jun. 4, 2021

Related U.S. Application Data
(60) Provisional application No. 63/034,785, filed on Jun. 4, 2020.

(51) Int. Cl. G01B 11/14; G01B 11/28; G01S 15/08; G01S 17/08; G06Q 10/08

(52) U.S. Cl. CPC G01B 11/14; G01B 11/285; G06Q 10/0833; G01S 17/08; G01S 15/08

(57) ABSTRACT

A system and method for identifying available cargo space and allocating that available cargo space while in transit includes a plurality of sensors for measuring space from reference surface of a cargo container to pallets in the cargo container. Such distances are aggregated to identify unused space in real time. The unused space is used by a freight management system to identify cargo along the same route that can use the unused space.

### PRIORITY

The present application claims the benefit under 35 U.S.C. § 119(e) of U.S. Provisional App. No. 63/034,785 (filed Jun. 4, 2020), which is incorporated herein by reference.

### BACKGROUND

Many logistics fleets operate with significant unused cargo capacity because they are unable to match available space currently in transit with new customers. Current capacity is usually unknown or must be tracked manually. To perform that matchmaking and optimize fleet capacity, the fleet operator needs to know cargo capacity of vehicles even in transit.

### SUMMARY

Embodiments of the inventive concepts disclosed herein are directed to a system and method for identifying available cargo space and allocating that available cargo space while in transit. The system includes a plurality of sensors for measuring space from reference surface of a cargo container to pallets in the cargo container. Such distances are aggregated to identify unused space in real time. The unused space is used by a freight management system to identify cargo along the same route that can use the unused space.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a block diagram of a system suitable for implementing embodiments of the present disclosure;

FIG. 2 shows a perspective, environmental, block view of a container including an exemplary embodiment of the present disclosure;

FIG. 3 shows a top, environmental, block view of a container including an exemplary embodiment of the present disclosure;

FIG. 4 shows a flowchart of a method for allocating available cargo space in transit according to an exemplary embodiment of the present disclosure;

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a system and method for identifying available cargo space and allocating that available cargo space while in transit. The system includes a plurality of sensors for measuring space from reference surface of a cargo container to pallets in the cargo container. Such distances are aggregated to identify unused space in real time. The unused space is used by a freight management system to identify cargo along the same route that can use the unused space. It may be appreciated that in the present context, “container” may refer to a cargo shipping container, separate from an actual transport, or to the cargo space portion of a cargo transport.

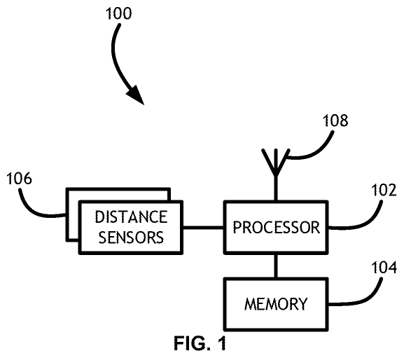

Referring to FIG. 1, a block diagram of a system 100 suitable for implementing embodiments of the present disclosure is shown. The system 100 includes a processor 102, memory 104 in data communication with the processor 102 for storing processor executable code, and a plurality of sensors 106 in data communication with the processor 102. The sensors 106 utilize distance measuring technology such as LIDAR, sonic, ultrasonic, laser, etc. In at least one embodiment, each sensor 106 may operate via a different technology or distinguishable frequencies utilizing the same technology to prevent interference between different sensors 106.

In at least one embodiment, the sensors 106 are disposed on interior surfaces of the container to measure the distance of cargo pallets (or any other type of packaging) from the rear and/or front wall of the container. The processor 102 receives data from the sensors 106 indicating distances of the cargo pallets from the rear and/or front surface of the container. The processor 102 the distances and known locations of the sensors 106 and aggregates the distance of corresponding sensors 106 along a common axis to identify total unused space along each axis. The total aggregate of unused space may comprise available cargo space, either in total within the container, or divided along each axis within the container.

In at least one embodiment, the system 100 includes a data communication element 108 in data communication with the processor 102. The processor 102 may communicate the identified available cargo space to a remote freight management system. Such data communication element 108 may include cellular components, WIFI, satellite communication components, Bluetooth, etc.

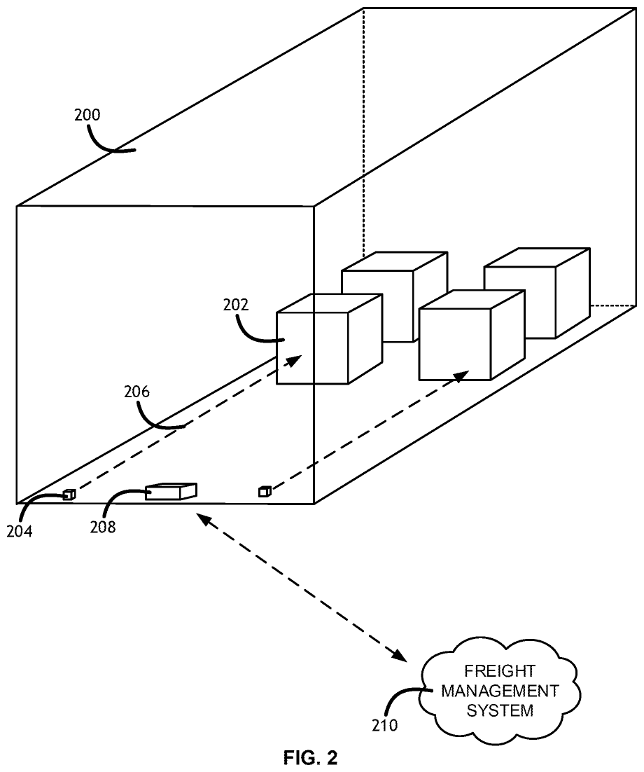

Referring to FIG. 2, a perspective, environmental, block view of a container 200 including an exemplary embodiment of the present disclosure is shown. Pallets 202 or other cargo units within the container 200 may be loaded front-to-back such that the pallets 202 are generally loaded furthest from the rear doors first. Distance sensors 204 are disposed near the rear door, oriented to measure the distance 206 from the rear door to the nearest pallet 202 along a corresponding axis. For example, a first distance sensor 204 may measure the distance 206 to a pallet along a first axis generally corresponding to a left-hand side of the container 200 while a second distance sensor 204 may measure the distance 206 to a pallet along a second axis generally corresponding to a right-hand side of the container 200.

As pallets 202 are removed from the container 200 over time, space is freed within the container 200. Such space may be generally represented by increased distance 206 measurements from the distance sensors 204. A controller 208, including a processor, battery, data communication elements, and location subsystems such as GPS, receives the distance 206 measurements and records them over time. Available space may be computed for each axis or by aggregating all distance 206 measurements for a total available area.

The controller 208 may communicate the available space and location to a remote freight management system 210. The freight management system 210 searches for cargo suitable for the available space near the container 200 with reference to the location received location. Alternatively, or in addition, the freight management system 210 may search for suitable cargo along a known route of the container 200.

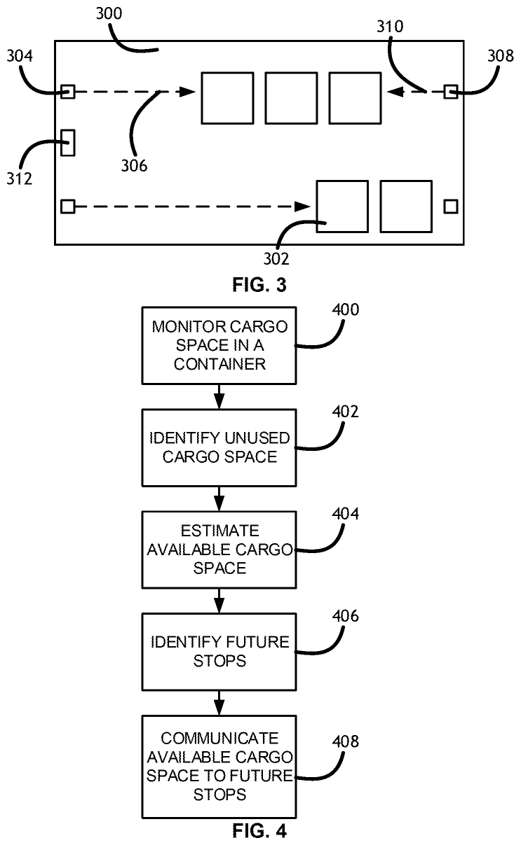

Referring to FIG. 3, a top, environmental, block view of a container 300 including an exemplary embodiment of the present disclosure is shown. Pallets 302 or other cargo units within the container 300 may be loaded front-to-back such that the pallets 302 are generally loaded furthest from the rear doors first; however, over time or due to loading errors, pallets 302 may become separated from the front of the container. Distance sensors 304, 308 are disposed near the rear door and near the front surface, oriented to measure the distance 306 from the rear door to the nearest pallet 302 and the distance 310 from the front surface respectively along the same axis.

A controller 312, including a processor, battery, data communication elements, and location subsystems such as GPS, receives the distance 306, 310 measurements and records them over time. Available space may be computed for each axis or by aggregating all distance 306, 310 measurements for a total available area. For example, along a first axis, the controller 312 may aggregate the distance 306 from the rear door and the distance 310 from the front surface to determine a total available space along the first axis if the pallets 302 where shifter forward.

Referring to FIG. 4, a flowchart of a method for allocating available cargo space in transit according to an exemplary embodiment of the present disclosure is shown. Cargo is placed in a cargo area; in at least one embodiment, the space utilized by each cargo element is recorded via on-board distance sensors. Cargo space is monitored 400 in the container; in at least one embodiment, such monitoring is initiated manually or based on some event such as the rear-door closing. Monitoring 400 may be continuous or periodic.

Unused space is identified 402 based on a distance between the rear-door and the nearest cargo being above a predefined threshold. Alternatively, or in addition, total distance from rear-doors and front surfaces may be aggregated, even if individual distances are below the threshold. Based on the identified space, available cargo space is estimated 404. In at least one embodiment, available cargo space estimation 404 includes an algorithm that uses preconfigured cargo space width and standardized pallet sizes.

In at least one embodiment, a freight management system, either on-board or remote, identifies future stops or waiting cargo shipments proximal to the known route of the container and available cargo space is communicated 408 as necessary to facilitate usage of the available cargo space.

It is believed that the inventive concepts disclosed herein and many of their attendant advantages will be understood by the foregoing description of embodiments of the inventive concepts disclosed, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The form herein before described being merely an explanatory embodiment thereof, it is the intention of the following claims to encompass and include such changes. Furthermore, any of the features disclosed in relation to any of the individual embodiments may be incorporated into any other embodiment.

What is claimed is:

1. A system comprising:
a plurality of distance sensors; and
at least one processor in data communication with the plurality of distance sensors and a memory for storing processor executable code to configure the at least one processor to:
receive a plurality of distance measurements from the plurality of distance sensors, each distance measurement corresponding to a distance of a cargo element from a reference surface inside a container;
identify unused floor space based on the distance measurements; and
calculate available cargo space based on the unused floor space.

2. The system of claim 1, wherein at least two of the plurality of distance sensors comprise ultrasonic sensors.

3. The system of claim 2, wherein each of the two ultrasonic sensors are configured to operate in a distinct frequency range.

4. The system of claim 1, wherein at least one of the plurality of distance sensors comprises a laser range finder.

5. The system of claim 1, wherein at least one of the plurality of distance sensors comprises a LIDAR.

6. The system of claim 1, wherein the at least one processor is further configured to:
establish a datalink connection with a remote freight management system; and
communicate the available cargo space to the remote freight management system.

7. The system of claim 6, further comprising a global navigation satellite receiver in data communication with the at least one processor, wherein the at least one processor is further configured to:
determine a current location of the system;
communicate the current the location to the remote freight management system; and
receive a destination corresponding to a cargo load determined to fit the available cargo space.

8. A parcel transport comprising:
a plurality of distance sensors; and
at least one processor in data communication with the plurality of distance sensors and a memory for storing processor executable code to configure the at least one processor to:
receive a plurality of distance measurements from the plurality of distance sensors, at least one distance measurement corresponding to a distance of a cargo element from a rear-surface along a first axis, and at least one distance measurement corresponding to a distance of a cargo element from a front-surface along the first axis;
aggregate the distance measurements;
identify unused floor space along the first axis based on the aggregated distance measurements; and
calculate available cargo space based on the unused floor space.

9. The parcel transport of claim 8, wherein at least two of the plurality of distance sensors comprise ultrasonic sensors.

10. The parcel transport of claim 9, wherein each of the two ultrasonic sensors are configured to operate in a distinct frequency range.

11. The parcel transport of claim 8, wherein at least one of the plurality of distance sensors comprises a laser range finder.

12. The parcel transport of claim 8, wherein at least one of the plurality of distance sensors comprises a LIDAR.

13. The parcel transport of claim 8, wherein at least one of the plurality of distance sensors is disposed on a door of the parcel transport.

14. The parcel transport of claim 13, wherein the at least one processor is further configured to:
determine when the door is opened based on signals from the at least one distance sensor disposed on the door; and
initiate a recalculation of the available cargo space.

15. The parcel transport of claim 14, wherein:
at least one of the plurality of distance sensors is disposed on a surface opposite the door of the parcel transport; and
the at least one processor is further configured to:
identify a shift in cargo disposition based on changes in distance measurements in the distance sensors is disposed on the door and the distance sensors is disposed on the surface opposite the door; and
report the cargo shift to a freight management system.

16. A method comprising:
receiving a plurality of distance measurements from a plurality of distance sensors disposed within a cargo container, at least one distance measurement corresponding to a distance of a cargo element from a rear-surface along a first axis, and at least one distance measurement corresponding to a distance of a cargo element from a front-surface along the first axis;
aggregating the distance measurements;
identifying unused floor space along the first axis based on the aggregated distance measurements; and
calculating available cargo space based on the unused floor space.

17. The method of claim 16, wherein:
at least one of the plurality of distance sensors is disposed on a door of the cargo container; and
further comprising:
determining when the door is opened based on signals from the at least one distance sensor disposed on the door; and
initiating a recalculation of the available cargo space.

18. The method of claim 17, wherein:
at least one of the plurality of distance sensors is disposed on a surface opposite the door of the parcel transport; and
further comprising:
identifying a shift in cargo disposition based on changes in distance measurements in the distance sensors is disposed on the door and the distance sensors is disposed on the surface opposite the door; and
reporting the cargo shift to a freight management system.

19. The method of claim 16, further comprising:
establishing a datalink connection with a remote freight management system; and
communicating the available cargo space to the remote freight management system.

20. The method of claim 19, further comprising:
determining a current location of the cargo container;
communicating the current the location to the remote freight management system; and
receiving a destination corresponding to a cargo load determined to fit the available cargo space along a current route.
